(19) United States
(12) Patent Application Publication
(10) Pub. No.: US 2025/0110601 A1
(43) Pub. Date: Apr. 3, 2025

(54) PROCESSING METHOD AND PROCESSING DEVICE

(71) Applicant: Lenovo (Beijing) Limited, Beijing (CN)

(72) Inventors: Mingping ZHANG, Beijing (CN); Yongchuan YE, Beijing (CN); Hainan CAI, Beijing (CN)

(21) Appl. No.: 18/896,585

(22) Filed: Sep. 25, 2024

(30) Foreign Application Priority Data
Sep. 28, 2023 (CN) 202311279107.X

(51) Int. Cl. G06F 3/0481; G06F 3/0484

(52) U.S. Cl. CPC G06F 3/0481; G06F 3/0484

(57) ABSTRACT

A processing method includes establishing a connection channel with a target device including a target screen; acquiring a target instruction based on a target operation acquired by the target device; acquiring target display content in a screen projection mode specified by the target instruction; and sending the target display content to the target device through the connection channel. The target screen outputs the target display content in a target window.

### CROSS-REFERENCE TO RELATED APPLICATION

This application claims priority of Chinese Patent Application No. 202311279107.X, filed on Sep. 28, 2023, the entire contents of which are hereby incorporated by reference.

### FIELD OF THE DISCLOSURE

The present disclosure generally relates to the field of screen display technology and, more particularly, relates to a processing method and a processing device.

### BACKGROUND

As screen projection technologies are widely used, content displayed on a screen of one electronic device may be projected onto a screen of another electronic device for display. However, when a screen of one electronic device, such as a mobile phone, is projected to another electronic device, like a computer, the computer can only passively receive and display content projected by the mobile phone and cannot adjust a display mode or content of the projected screen, thereby preventing the computer from meeting user's screen projection needs in different application scenarios.

### BRIEF SUMMARY OF THE DISCLOSURE

One aspect of the present disclosure provides a processing method. The processing method includes establishing a connection channel with a target device including a target screen; acquiring a target instruction based on a target operation acquired by the target device; acquiring target display content in a screen projection mode specified by the target instruction; and sending the target display content to the target device through the connection channel. The target screen outputs the target display content in a target window.

Another aspect of the present disclosure provides a processing device. The processing device includes an establishment module, for establishing a connection channel with a target device including a target screen; a first acquisition module, for acquiring a target instruction based on an instruction generated by a target operation acquired by the target device; a second acquisition module, for acquiring target display content in a screen projection mode specified by the target instruction based on the target instruction; and a sending module, for sending the target display content to the target device through the connection channel. The target screen outputs the target display content in a target window.

Another aspect of the present disclosure provides an electronic device. The electronic device includes at least a memory, a processor and a bus. The memory stores machine-readable instructions executable by the processor. When the electronic device is operating, the processor and the memory communicate through a bus. When executed by the processor, the machine-readable instructions implement steps in a processing method. The processing method includes establishing a connection channel with a target device including a target screen; acquiring a target instruction based on a target operation acquired by the target device; acquiring target display content in a screen projection mode specified by the target instruction; and sending the target display content to the target device through the connection channel, so that the target screen outputs the target display content in a target window.

Another aspect of the present disclosure provides a non-transitory computer readable storage medium containing computer program that, when being executed, causes at least one processor to perform: establishing a connection channel with a target device including a target screen; acquiring a target instruction based on a target operation acquired by the target device; acquiring target display content in a screen projection mode specified by the target instruction; and sending the target display content to the target device through the connection channel. The target screen outputs the target display content in a target window.

Another aspect of the present disclosure provides a computer-readable storage medium on which a computer program is stored. When the computer program is run by a processor, the computer program implements steps of a processing method. The processing method includes establishing a connection channel with a target device including a target screen; acquiring a target instruction based on a target operation acquired by the target device; acquiring target display content in a screen projection mode specified by the target instruction; and sending the target display content to the target device through the connection channel, so that the target screen outputs the target display content in a target window.

Other aspects of the present disclosure can be understood by a person skilled in the art in light of the description, the claims, and the drawings of the present disclosure.

### BRIEF DESCRIPTION OF THE DRAWINGS

To describe technical solutions in embodiments of the present disclosure more clearly, accompanying drawings required to be used in the embodiments of the present disclosure will be briefly introduced below. Obviously, the accompanying drawings described below are some embodiments of the present disclosure. A person skilled in the art may further derive other drawings from the accompanying drawings without creative efforts.

FIG. 1 illustrates a flow chart of a processing method consistent with various embodiments of the present disclosure.

FIG. 2 illustrates a scene diagram before switching to a screen projection mode in a processing method consistent with various embodiments of the present disclosure.

FIG. 3 illustrates a scene diagram after switching to a screen projection mode in a processing method consistent with various embodiments of the present disclosure.

FIG. 4 illustrates a block diagram of a processing device consistent with various embodiments of the present disclosure.

FIG. 5 illustrates a structural view of an electronic device consistent with various embodiments of the present disclosure.

### DETAILED DESCRIPTION

Various aspects and features of the present disclosure are described with reference to the accompanying drawings.

It will be understood that various modifications may be made to the embodiments described herein. Therefore, the present specification should not be construed as limiting but merely as illustrative of the embodiments. Other modifications within the scope and spirit of the present disclosure will be apparent to a person skilled in the art.

The accompanying drawings, which are incorporated in and constitute a part of the present specification, illustrate the embodiments of the present disclosure. Together with the general description of the present disclosure provided above and the detailed description of the embodiments below, the accompanying drawings serve to explain principles of the present disclosure.

Features of the present disclosure will become apparent from the following description of preferred embodiments, which are provided as non-limiting examples with reference to the accompanying drawings.

It is further to be understood that, although the present disclosure has been described with reference to a few specific examples, a person skilled in the art can implement various equivalent forms of the present disclosure, which have characteristics as claimed and therefore all fall within the defined scope of protection.

The above and other aspects, features, and advantages of the present disclosure will become more apparent from the following detailed description with reference to the accompanying drawings.

Specific embodiments of the present disclosure are described below with reference to the accompanying drawings. However, the specific embodiments are merely examples of the present disclosure, which may be implemented in various ways. Well-known and/or repetitive functions and structures have not been described in detail to avoid obscuring the present disclosure with unnecessary or redundant details. Therefore, specific structural and functional details claimed herein are not intended to be limiting, but merely serve as a basis and representative basis for the claims and serve to instruct a person skilled in the art on how to use the present disclosure in various suitable configurations.

The present specification may use phrases such as “in one embodiment,” “in another embodiment,” “in yet another embodiment,” or “in other embodiments,” which may refer to one or more of same or different embodiments according to the present disclosure.

Currently, a user can only project a screen of a mobile phone onto a computer from the mobile phone. The mobile phone can offer a variety of screen projection modes for the user to choose from. Display content will be projected onto a computer's display screen according to a projection mode selected by the user. However, the computer can only project the screen based on the display content sent by the mobile phone. After receiving and displaying the display content of the projected screen, the computer cannot further control or adjust the display content or mode. Any adjustments must be made by performing corresponding operations on the mobile phone.

Therefore, the embodiments of the present disclosure provide a processing method applied to an electronic device for projecting a screen to a target device. After the electronic device establishes a connection channel with a target device, a target instruction can be acquired based on a target operation acquired by the target device. A screen projection mode is determined according to the target instruction, and target display content for screen projection is acquired. The target display content is sent to a target window of the target device for display, so that a user can realize a screen display of the electronic device on the target device without operating on the electronic device, thereby improving a user's control experience with the target device.

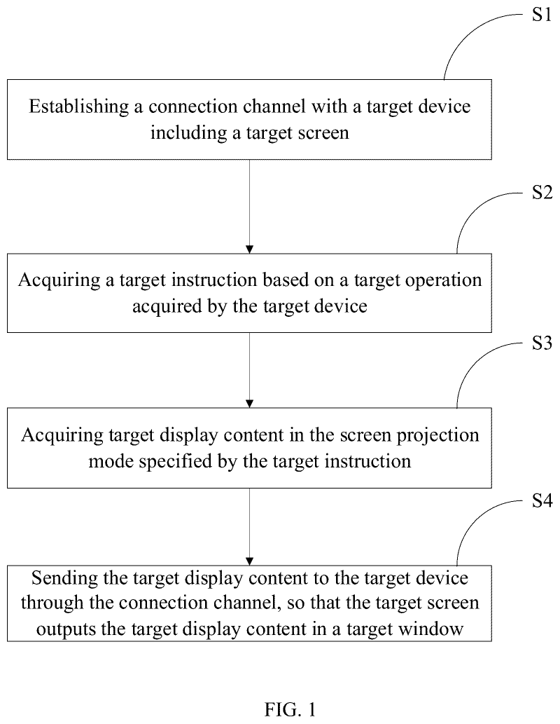

FIG. 1 illustrates a flow chart of a processing method consistent with various embodiments of the present disclosure. As illustrated in FIG. 1, a processing method is provided in one embodiment, which is applied to an electronic device that projects a screen to a target device. A screen projection device can be a mobile phone, tablet, computer, or any other device with a display screen. A target device can be a device with a display screen such as a mobile phone, tablet, or computer, or an independent monitor capable of receiving operations and projecting screens.

In one embodiment, as an example, a mobile phone acting as the screen projection device and a computer serving as the target device are used to explain the processing method in detail. The processing method may include the following steps S1-S4.
S1: establishing a connection channel with a target device including a target screen.

In the present step, when display content of the screen projection device needs to be projected to the target screen of the target device, the electronic device and the target device are connected through either a wired or wireless connection, establishing a connection channel between the electronic device and the target device through which screen projection data can be transmitted. In some practical applications, the target device can be configured with a plurality of display screens. Through a selection operation, the user can choose one display screen of the plurality of display screens as the target screen for receiving screen projection from the electronic device. Alternatively, the target device can also automatically select a display screen that receives a screen projection by default or choose a display screen based on the user's historical operations as the target screen for receiving a screen projection from the electronic device. For example, in the embodiment, when the screen projection device is a mobile phone and the target device is a computer, the mobile phone can be connected to the computer through either a wired or wireless connection, so that a connection channel can be established between the mobile phone and the computer for data transmission.
S2: acquiring a target instruction based on a target operation acquired by the target device.

After the screen projection device establishes the connection channel with the target device, when the target device acquires an operation related to screen projection, the screen projection device can acquire instruction information corresponding to the target operation on the target device to acquire the target instruction. In some practical applications, the target operation may be a user's operation to select a screen projection mode on the target device. For example, a button to select a screen projection mode may be provided on a display screen of the computer. When a user uses a mouse or touch screen to display a screen and selects a button in the projection mode to perform a click operation, the computer acquires the target operation. Based on the user's click operation, the computer determines the screen projection mode selected by the user based on the user's click operation, acquires the instruction information of the click operation, and sends the instruction information to the mobile phone. The mobile phone acquires the target instruction. Alternatively, based on the click operation acquired by the computer and the instruction information triggered by a click position, the mobile phone can acquire the target instruction indicating the screen projection mode.
S3: acquiring target display content in the screen projection mode specified by the target instruction.

In one embodiment, after the screen projection device acquires the target instruction, in response to the target instruction, a corresponding screen projection mode can be determined, and the target display content for screen projection can be acquired according to the screen projection mode. The target display content can either be a display interface of various applications running on the screen projection device or a main interface when no applications are active. In some specific applications, the screen projection device can provide a plurality of screen projection modes. In different screen projection modes, the target display content projected to the target device for display is identical or different. A specific display form of the target display content after projection can either match or differ from the original, with the details configurable by technical personnel. For example, the mobile phone can provide three screen projection modes: computer screen projection mode, mirror mode and terminal screen projection mode (mobile phone screen projection mode). The screen projection mode specified by a user can be determined according to the target instruction to acquire the target display content for display on the target device.
S4: sending the target display content to the target device through the connection channel, so that the target screen outputs the target display content in a target window.

A size of the target window can be determined based on the screen projection mode. For example, in the computer screen projection mode, the size of the target window is an entire area of the display screen of the target device, in the mirror or terminal screen projection mode, the size of the target window can be the size of part or all of the display area of the screen projection device.

After the screen projection device acquires the target display content, the target display content can be sent to the target device through the connection channel and the target display content can be output in the target window of the display screen of the target device to achieve screen projection.

For example, in one embodiment, in some practical application scenarios, when a user uses a computer and wants to know how his or her child is attending online classes on a mobile phone in a next room, the user can synchronize the display content of the mobile phone to a display screen of the computer based on the mirror mode, so that the computer can display the current display content of the mobile phone screen in real time. When the display content of the mobile phone needs to be projected to the display screen of the computer, the mobile phone is the screen projection device, and the computer is the target device for displaying the target display content. A Bluetooth connection can be utilized to link the mobile phone and computer, establishing a communication channel between the two devices. The user can click on a selection button for projection modes provided on the display screen of the computer. For example, if a button for the mirror mode is clicked, the computer can generate an instruction indicating the mirror mode and send the instruction to the mobile phone. After receiving the target instruction specifying the mirror mode, the mobile phone responds by acquiring display data of the mobile phone screen according to the mirror mode, thereby acquiring the target display content for screen projection. The mobile phone sends the target display content to the computer through the connection channel, enabling the computer to output the target display content through the target window. The mobile phone can acquire the target instruction specifying the screen projection mode according to a user's operation on the computer to enable screen projection. The operation process is straightforward and user-friendly, resulting in a positive user experience.

In one embodiment, when the electronic device requires a screen projection, the electronic device can acquire the target instruction specifying the screen projection mode based on a user-generated instruction through a target operation on the target device, so that the target display content is acquired according to the screen projection mode, and displayed on the target device, enabling the user to engage in an interactive screen projection experience through the operation on the target device.

In some embodiments, acquiring the target instruction includes acquiring the target display content based on a first screen projection mode; and sending the target display content to the target device through the connection channel, so that the target screen outputs the target display content of a first window in a first form.

Acquiring the target display content in the projection mode specified by the target instruction based on the target instruction includes switching the screen projection mode from the first screen projection mode to a second screen projection mode based on the target instruction.

When the target display content is acquired based on the second screen projection mode, the target display content is sent to the target device through the connection channel, so that the target screen outputs the target display content of a second window in a second form. The first screen projection mode is different from the second screen projection mode, and the first form is different from the second form.

The embodiment aims to switch the screen projection mode according to the target instruction to change a display form of the target display content. In one embodiment, the first screen projection mode can be determined by the screen projection device according to a default setting or chosen by the user through selection. The embodiment does not limit the method of determining the first screen projection mode.

When the target display content is acquired based on the first screen projection mode, the target display content is same as the target display content in the previous embodiment. That is, before acquiring the target instruction, the screen projection device sends the target display content to the target device through the first screen projection mode, to output the target display content in the first form through the first window of the target screen for screen projection. The first form at least includes a layout form used for displaying the target display content. For example, when a mobile phone is used as a screen projection device, the target display content is provided on a main screen, and icons of a plurality of installed applications are displayed in the target display content. When the target display content is projected onto the first window for output, the icons are arranged in a corresponding layout. A size of the first window is determined based on a setting of the first screen projection mode and can refer to an implementation of the target window in the previous embodiment.

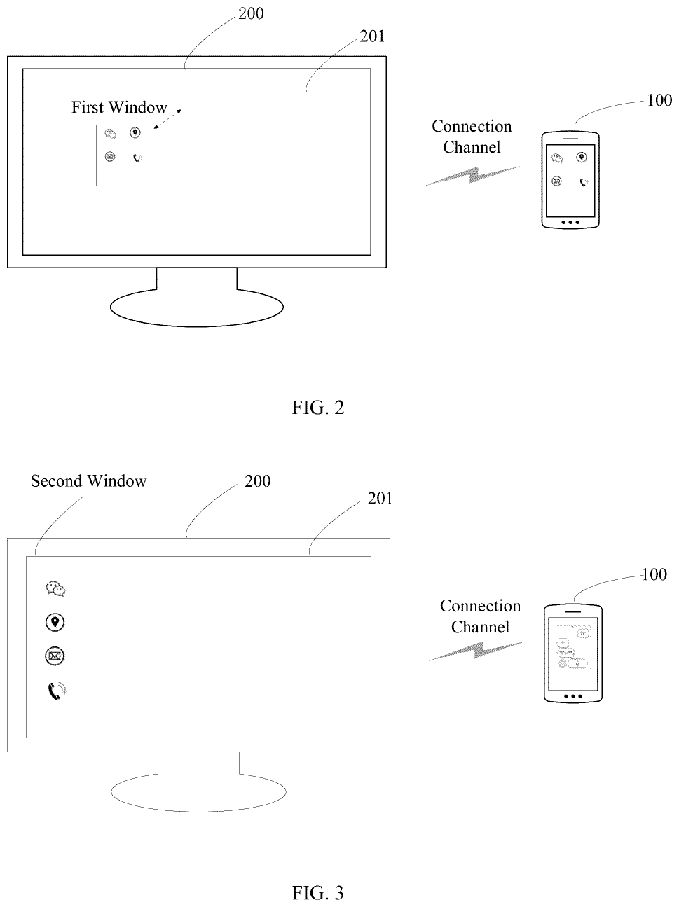

After the target instruction is acquired, if the target instruction specifies that the screen projection mode is the second screen projection mode, the screen projection mode is switched from the first screen projection mode to the second screen projection mode. The second screen projection mode is a different from the first screen projection mode, while the target display content remains identical in both modes. The second window differs in size from the first window. The second form is different from the first form, that is, when the target display content is output in the second window, an icon layout of application programs in the second form is different from an icon layout of the application programs in the first window. For example, when the first window is output in the first form, icons of application programs may be arranged in a grid pattern, starting from an upper left corner and arranged row by row from left to right. When a larger second window is output in the second form, number of icons per row increases while maintaining a same arrangement. Details of the icon layout of application programs can be referenced in the first window and the second window illustrated in FIG. 2 and FIG. 3.

For example, in some practical application scenarios of the embodiment, when a user watches a video on a mobile phone and wants to view the video on a larger screen, the user can project the screen to a computer. In one embodiment, when a video played by the mobile phone needs to be projected to a display screen of the computer, a user can select a projection mode by clicking on the mobile phone. The mobile phone determines to project the screen in the first projection mode according to a user's operation instruction. The mobile phone acquires playback content of the video as the target display content and sends the playback content of the video to the computer, so that the computer can output the playback content of the video in the first form through an entire screen area of the first window according to a setting of the first screen projection mode.

While watching the screen projection video on the computer, if a user needs to perform tasks on the computer, the user can click on a selection button on the computer to select the terminal screen projection mode. Based on the user's click operation, the computer can generate an instruction specifying the terminal's screen projection mode and send the instruction to the mobile phone. In response to the target instruction, after acquiring the target instruction specifying the terminal's screen projection mode, the mobile phone continues to acquire the playback content of the mobile video application according to the terminal projection mode to obtain the target display content of the terminal projection mode, and transmits the target display content to the computer through the connection channel, so that the computer can output the playback content of the video through a window of a terminal screen. In the embodiment, during a screen projection process, when the size of the output window of screen projection content needs to be changed, the mobile phone can receive a target instruction from the computer to switch the current screen projection mode, enabling the user to easily change the screen projection mode.

In one embodiment, the acquiring the target instruction includes transmitting and receiving the target instruction through the connection channel, and the target instruction being generated by a target operation acquired by the target device.

In the embodiment, after receiving the user's target operation through the target device, instruction information corresponding to the target operation can be directly determined, so that the screen projection device can acquire the instruction information from the target device through the connection channel, thereby receiving the target instruction. For example, when acquiring the user's click operation for the screen projection mode, the computer can determine that the instruction information corresponding to the click operation is to select the screen projection mode and send the instruction information for selecting the screen projection mode to the mobile phone through the connection channel. The mobile phone can acquire the target instruction specifying the screen projection mode through the connection channel.

In some embodiments, acquiring the target instruction includes one of the following: receiving target operation information through the connection channel, a target operation being an adjustment operation for the first window acquired by the target device, determining the target instruction if the target operation information specifies that a size of the first window matches a size of the second window in the second screen projection mode; or transmitting and receiving target operation information through the connection channel, the target operation being a target size acquired by the target device for the adjustment operation of the first window, determining the target instruction if the target operation information specifies that a size of the first window matches a size of the second window in the second screen projection mode.

In the embodiment, the screen projection device acquires the target instruction according to the adjustment operation for the first window acquired by the target device to implement switching of the screen projection mode.

In some specific applications, when the target device acquires an adjustment operation for the first window, the screen projection device determines an adjustment size of the first window based on the adjustment operation and calculates the adjustment size of the first window using an initial size of the first window and the adjustment size information prior to adjustment. For example, if a user needs to switch the screen projection mode while watching the screen projection content through the first window on the computer, the user can drag a first window border with a cursor to change the size of the first window that outputs the screen projection content. The screen projection device can acquire movement information of the window border dragged by the cursor on the target device and acquire resizing information for the first window based on the movement. The screen projection device can determine the size of the first window after adjustment based on an initial size and the adjustment size information of the first window before adjustment.

The screen projection device compares the adjusted size of the first window with a window size in each screen projection mode. If the size of the second window in the second screen projection mode matches the adjusted size of the first window, the instruction corresponding to the target operation is determined, and the screen projection device determines and obtains the target instruction.

Optionally, when the target device acquires the adjustment operation for the first window, the target device can acquire target size information corresponding to the adjusted first window according to adjustment size information corresponding to the adjustment operation and send the target size information to the screen projection device through the connection channel. For example, when the user watches the screen projection content through the first window on the computer, and needs to switch the screen projection mode, after changing the size of the first window that outputs the projection content by dragging the border of the first window with the cursor, the target device can determine the target size of the adjusted first window based on the movement information when the cursor is dragged, and send the target size information to the screen projection device.

After receiving the adjusted target size of the first window, the screen projection device compares the target size with a window size in each screen projection mode. If the size of the second window in the second screen projection mode matches the target size, the size of the second window can be determined. The screen projection device determines and acquires the target instruction.

In some embodiments, acquiring the target display content in the screen projection mode specified by the target instruction includes acquiring and sending first target display content in the first screen projection mode based on the target instruction, so that a first area of the target screen displays first display content based on the first window with the size of the first window matching a size of the first area; and acquiring and sending the second target display content in the second screen projection mode based on the target instruction, so that the second area of the target screen displays the second display content based on the second window, with the size of the second window matching a size of the second area.

The screen projection mode includes options to control the display content and the window size. Different screen projection modes can feature different display content, layouts, window sizes, or combinations of content and window size to suit various usage scenarios.

In one embodiment, if the target instruction specifies the first screen projection mode, when executing the target instruction, according to the first screen projection mode, the screen projection device acquires the first target display content and the size information of the first window and sends the first target display content and the size information of the first window to the target device. The target device selects an adapted first area on the target screen according to the size of the first window, and outputs the first target display content of the first window in the first area to implement screen projection in the first screen projection mode.

Optionally, if the target instruction specifies the second screen projection mode, when executing the target instruction, according to the first screen projection mode, the screen projection device acquires the second target display content and the size information of the second window and send the second target display content and the size information of the second window to the target device. The target device selects an adapted first area on the target screen according to the size of the second window, and outputs the first target display content of the first window in the first area to implement screen projection in the first screen projection mode.

The size of the second window may be same as or different from the first window, and the second target display content may be same as or different from the first target display content. For example, when the first screen projection mode is the mirror mode and the second screen projection mode is the terminal screen projection mode, the first window and the second window may have a same size as the terminal device, and the second window may have a same size as the first window. In the mirror mode, the target display content remains same as the screen display content of the screen projection device, that is, the target display content output by the target window of the target device also remains same as the screen display content of the screen projection device. In the terminal screen projection mode, during the screen projection process, the terminal device can change screen content based on further operations, such as exiting an application displayed on the screen during screen projection, entering a home screen or entering other applications. The screen projection content can also be operated on the target device. For example, when the target display content is an application, a corresponding display content can be displayed according to controls provided in the application. That is, in the terminal screen projection mode, changes in the screen display content of the projection device don't affect the projection content output on the target device. Operations on the screen projection content performed on the target device will not affect the screen projection content of the projection device. The second target display content is different from the first target display content.

In some embodiments, the target operation is a screen splitting operation acquired by the target device for the target screen, which divides the target screen into a first area and a second area that does not overlap the first area.

In the embodiment, when a user performs a split-screen operation on the target screen of the target device, the screen projection device acquires the split-screen operation information from the target device through the connection channel and determines and acquires the target instruction. The split-screen operation can divide the target screen into a first area and a second area without overlap between the first area and the second area, so that each corresponding window can be fully displayed. The sizes of the first area and the second area can each occupy 50% of the target screen by default or can be set according to user's actual needs.

For example, when a user needs to watch a screencast video on the computer and view a screen of the mobile phone simultaneously, or when the user needs to watch a video while operating an application on the computer, the user can use a split-screen function to divide the display screen into the first area and the second area as needed. When acquiring split-screen operation information from the computer through the connection channel, the mobile phone determines to acquire the target instruction. According to the target instruction, the mobile phone acquires the first target display content and the second target display content, as well as sizes of the first and second windows based on the first and second screen projection mode respectively, The mobile phone sends the first and second target display content, as well as window size information to the computer, so that the computer can output the first target display content of the first window in the first area, and output the second target display content of the second window in the second area.

In one embodiment, the first target display content and the second display content may be identical or different. For example, the first target display content and the second target display content may both be a home screen of the mobile phone, and the display content includes a plurality of application icons. A user can click a first application icon on the first target display content of the first window output in the first area to launch the first application and can also click the second application on the second target display content of the second window output in the second area to launch the second application, that is, interface information of the two mobile applications can be displayed on the target screen simultaneously for the user to view and operate.

For example, a user can set the home screen of the mobile phone as the first target display content in the first screen projection mode and set the second screen projection mode to acquire the second target display content from a current screen display content of the mobile phone when acquiring the corresponding target indication. When the current screen display content is not the home screen of the mobile phone, or the second screen projection mode is the mirror mode, the first target display content is different from the second target display content. The user can click an application icon based on the first target display content in the first area to launch the application. The user can display the second display content of the second window in the second area, which matches the display content of a mobile phone screen or choose to launch the second display content of other applications.

For example, FIGS. 2 and 3 illustrate schematic diagrams of scenes before and after switching the screen projection mode in a processing method consistent with various embodiments of the present disclosure. As illustrated in FIGS. 2 and 3, in one embodiment, application scenarios of the processing method include at least a mobile phone 100 and a computer 200. The mobile phone 100 is a screen projection device, and the computer 200 is a target device. The display screen 201 of the computer 200 is a target screen, which is used to output the target display content of the target window during screen projection.

When a user needs to project display content from the mobile phone 100 to the computer 200 for display, the user connects the mobile phone 100 and the computer 200 through a cable connection or a wireless connection to establish a connection channel between the mobile phone 100 and the computer 200. The user can select a screen projection mode on the mobile phone 100, which receives a first screen projection instruction to initiate screen projection.

For example, the mobile phone 100 acquires a currently displayed screen content according to the terminal screen projection mode selected by the user. As illustrated in FIG. 3, the mobile phone 100 displays the target display content on the home screen, which is sent to the computer 200 through the connection channel, so that the computer 200 can output the target display content in a first window on the display screen 201. In the terminal screen projection mode, a size of the first window on the display screen 201 of the computer 200 is equivalent to a size of the mobile phone 100. A user can click and operate each icon in the target display content on the computer 200 without affecting screen display content of the mobile phone 100. The user can also click and operate various icons on the home screen after the screen is projected on the mobile phone 100, and the screen display content of the computer 200 is not affected.

During a screen projection process, if a user needs to display the target display content in a larger window, the user needs to switch the screen projection mode. The user can control a cursor on the display screen 201 of the computer 200 and drag a border of the first window to a position of the dotted box illustrated in FIG. 2 to resize the first window. By acquiring movement information when the cursor is dragged, the computer 200 can determine a target size of the adjusted first window and send target size information to the mobile phone 100.

When the mobile phone 100 receives target size information of the first window after adjustment, the mobile phone 100 compares the target size with a window size of each screen projection mode. If it is determined that the target size matches a second window in the computer screen projection mode (i.e., desktop screen projection), instruction information related to the drag operation can be determined, and the screen projection device determines and acquires the target instruction. The mobile phone switches from the mobile phone screen projection mode to the computer screen projection mode according to the computer screen projection mode specified by the target instruction. The computer 200 can output the second display content in the second window on the display screen 201 that matches the target size. When the mobile phone 100 switches to the screen projection mode according to the target instruction, the screen content can display a currently running communication software without affecting the target display content displayed in the second window on the computer 200.

After the screen projection mode is switched from the mobile phone screen projection mode to the computer screen projection mode, the target display content acquired before and after the switch does not change, but the target display content is displayed in different forms in the first and second windows. In the mobile screen projection mode, when the target display content is displayed in the first window, an arrangement of each application icon is same as a layout of a mobile phone screen, starting from an upper left corner and arranged row by row from left to right. In the computer screen projection mode, when the target display content is displayed in the second window, the size of the second window is larger than the size of the first window. A display size of each application icon can also be increased according to settings. An arrangement of each application icon is same as a layout of a computer screen, starting from an upper left corner and arranged column by column from top to bottom.

It should be noted that when switching from the mobile phone screen projection mode (or computer screen projection mode) to the mirror screen projection mode, which displays a same content as a mobile phone screen, in switching from the mobile phone screen projection mode to the mirror mode or from the computer screen projection mode to the mirror screen projection mode, the target display content output by the computer 200 in the second window may remain same as before the switch or differ. For example, user A triggers a use of a mobile phone on the computer 200 in the mobile screen projection mode. The first window of the computer 200 displays the first target display content. If the mobile phone is taken away and used by others (e.g., user A's children), the screen projection mode of the mobile phone ensures that other people's activity on the mobile phone does not affect user A's usage on the computer 200. However, if user A needs to check what others (e.g., user A's children) are doing with the mobile phone (e.g., playing games or studying online), the user can operate on the computer 200 to trigger the mobile phone (e.g., by dragging the first window to resize) and switch the mobile phone to the mirror mode. Since the mirror mode exactly replicates a display content of a mobile phone screen, user A can know what others are doing with the mobile phone through the second target display content output in the updated second window. The second target display content is an exact mirror of what is currently shown on the mobile phone screen but differs from a previous display content of the first target.

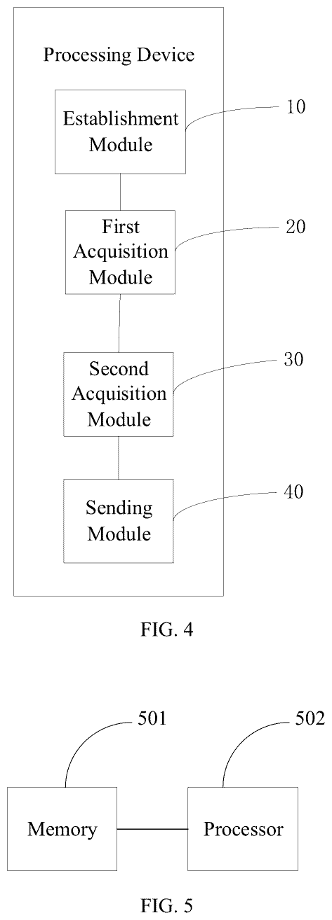

A processing device is provided in one embodiment. As illustrated in FIG. 4, the he processing device includes an establishment module 10, for establishing a connection channel with a target device including a target screen; a first acquisition module 20, for acquiring a target instruction generated by a target operation acquired by the target device; a second acquisition module 30, for acquiring target display content in a screen projection mode specified by the target instruction; and a sending module 40, for sending the target display content to a target device through a connection channel, so that the target screen outputs the target display content in a target window.

In some embodiments, before acquiring the target instruction, the second acquisition module is also configured for acquiring the target display content based on a first screen projection mode. The sending module is further configured for sending the target display content to the target device through the connection channel, so that the target screen outputs the target display content in the first window in a first form. The second acquisition module includes a switching unit configured for switching the screen projection mode from the first screen projection mode to a second screen projection mode based on the target instruction. The second acquisition module is further configured for acquiring the target display content based on the second screen projection mode. The target display content is sent to the target device through the connection channel, so that the target screen outputs the target display content of the second window in a second form, the first screen projection mode is different from the second screen projection mode, and the first form is different from the second form.

Optionally, in some embodiments, the first acquisition module is further configured for transmitting and receiving the target instruction through the connection channel, and the target instruction being generated by a target operation acquired by the target device.

In some embodiments, the first acquisition module is further configured for transmitting and receiving target operation information through the connection channel, the target operation being an adjustment operation for the first window acquired by the target device, and determining the target instruction if the target operation information specifies that the size of the first window matches the size of the second window corresponding to the second screen projection mode; or transmitting and receiving target operation information through the connection channel, the target operation being a target size for adjusting the first window acquired by the target device, and determining the target instruction if the target operation information specifies that the target size of the first window matches the size of the second window corresponding to the second screen projection mode.

In the embodiment, the processing device can implement steps of the processing method described in any of the above embodiments of the present disclosure through the establishment module 10, the first acquisition module 20, the second acquisition module 30 and the sending module 40, which will not be repeated herein.

An electronic device, including at least a memory 501, a processor 502 and a bus (not shown) is provided in one embodiment. FIG. 5 illustrates a schematic diagram of the electronic device. The memory 501 stores machine-readable instructions executable by the processor 502. During an operation of the electronic device, the processor 502 and the memory 501 communicate through the bus. When executed by the processor, the machine-readable instructions implement steps of the processing method provided by any of the above of the present disclosure.

Since the electronic device includes a memory for implementing the processing method disclosed in the embodiments of the present disclosure, a person skilled in the art will understand the structure and possible modifications of the electronic device introduced based on the processing method disclosed, which are not repeated herein.

A computer-readable storage medium on which a computer program is stored is provided in one embodiment. When the computer program is run by a processor, any step in the processing method provided by any of the above embodiments is implemented. The storage medium may be included in an electronic device; or exist separately without being assembled into an electronic device. The storage medium carries one or more computer programs. When the one or more computer programs are executed, steps of the processing method described in any of the above embodiments of the present disclosure are implemented.

According to the embodiments of the present disclosure, the computer-readable storage medium may be a non-volatile computer-readable storage medium, which may include, but is not limited to, portable computer disk, hard disk, random access memory (RAM), and read-only memory (ROM), erasable programmable read-only memory (EPROM or flash memory), portable compact disk read-only memory (CD-ROM), optical storage device, magnetic storage device, or any suitable combination of the above. Optionally, for specific examples in the embodiment, reference may be made to the examples described in any embodiment of the present disclosure, which will not be repeated herein. Obviously, a person skilled in the art should understand that each step of the processing method can be implemented using a general-purpose computing device, which may be centralized on a single computing device or distributed across a network of a plurality of computing devices. Alternatively, each step of the processing method can be implemented through computer programs executable by a computing device, so that each step of the processing method may be stored in a storage device and executed by the computing device. In some cases, steps shown or described may be implemented in a sequence different from what is described here, either by implementing the steps as separate integrated circuit modules or by combining a plurality of steps into a single integrated circuit module. The present disclosure is not limited to any specific combination of hardware and software.

Although the embodiments have been described herein with reference to the accompanying drawings, the embodiments are exemplary only and are not intended to limit the scope of the present disclosure. Various changes and modifications can be made by a person skilled in the art without departing from the scope and spirit of the present disclosure. All the changes and modifications are intended to be included within the scope of the present disclosure as claimed in the appended claims.

A person skilled in the art may understand that units and algorithm described in steps of each example of the embodiments disclosed herein can be implemented using electronic hardware, or a combination of computer software and electronic hardware. Whether functions are performed in hardware or software depends on a specific application and design constraints of a technical solution. A person skilled in the art may implement different methods to achieve the described functions in each specific application. However, the implementations should not be considered outside the scope of the present disclosure.

In some embodiments, the disclosed devices and methods can be implemented in other ways. For example, the device embodiment described above is only illustrative. A division of modules or units is only a logical function division. In actual implementation, other division methods may be used. For example, a plurality of units or components may be combined or integrated into another device, or specific features may be omitted, or not performed.

The present specification provides many specific details. However, the embodiments of the present disclosure may be practiced without the specific details. In some embodiments, well-known methods, structures, and techniques are not described in detail to avoid obscuring an understanding of the present specification.

Similarly, in the description of the exemplary embodiments of the present disclosure, to streamline the disclosure and aid in the understanding of one or more inventive aspects, various features are sometimes grouped together into a single embodiment, figure, or description. The processing method described in the present disclosure should not be interpreted to imply that the claimed application includes additional features beyond the features expressly listed in each claim. As reflected in the corresponding claims, the inventive concept lies in that part of features in a specific disclosed single embodiment can be applied to solve a corresponding technical problem. Therefore, the claims following detailed implementations are expressly incorporated into the detailed implementations, with each claim standing alone as an independent embodiment of the present disclosure.

A person skilled in the art can understand that all features disclosed in the present specification (including the accompanying claims, abstract, and drawings), as well as all processes or elements of any method or device disclosed, may be combined in any manner, except where the features are mutually exclusive. Unless expressly stated otherwise, each feature disclosed in the present specification (including accompanying claims, abstract and drawings) may be replaced by alternative features serving a same, equivalent or similar purpose.

Furthermore, a person skilled in the art can understand that although some embodiments described herein include certain features from other embodiments but not all, combinations of features from different embodiments are intended to fall within the scope of the present disclosure and form distinct embodiments. For example, in the claims, any of the claimed embodiments may be combined in any way.

Various component embodiments of the present disclosure may be implemented in hardware, software modules running on one or more processors, or a combination of both hardware and software modules. A person skilled in the art can understand that a microprocessor or digital signal processor (DSP) can be used to implement some or all functions of certain modules according to the embodiments of the present disclosure. The present disclosure may also be implemented as a device program (e.g., computer program and computer program product) for performing part or all of the methods described herein. A program implementing the present disclosure may be stored on a computer-readable medium or may take a form of one or more signals. The signals may be downloaded from an internet website, or transmitted via a carrier signal, or delivered in any other form.

As disclosed, the processing method and processing device provided by the present disclosure at least realize the following beneficial effects.

In the processing method, after an electronic device establishes a connection channel with a target device, a target instruction can be acquired based on a target operation acquired by the target device. A screen projection mode is determined according to the target instruction, and target display content for screen projection is acquired. The target display content is sent to a target window of the target device for display, so that a user can realize a screen display of the electronic device on the target device without operating on the electronic device, thereby improving a user's control experience with the target device.

The above are only specific embodiments or implementations of the present disclosure and do not limit the protection scope of the present disclosure. A person skilled in the art can easily make changes or substitutions within the technical scope disclosed in the present disclosure, which should be covered by the protection scope of the present disclosure. The protection scope of the present disclosure is defined by the claims.

What is claimed is:

1. A processing method, comprising:
establishing a connection channel with a target device including a target screen;
acquiring a target instruction based on a target operation acquired by the target device;
acquiring target display content in a screen projection mode specified by the target instruction; and
sending the target display content to the target device through the connection channel, wherein the target screen outputs the target display content in a target window.

2. The processing method according to claim 1, before acquiring the target instruction, further comprising:
acquiring the target display content based on a first screen projection mode;
sending the target display content to the target device through the connection channel, wherein the target screen outputs the target display content of a first window in a first form; and
acquiring the target display content in the screen projection mode specified by the target instruction including:
switching the screen projection mode from the first screen projection mode to a second screen projection mode based on the target instruction, and
acquiring the target display content based on the second screen projection mode, the target display content being sent to the target device through the connection channel, wherein the target screen outputs the target display content of a second window in a second form, the first screen projection mode being different from the second screen projection mode, and the first form being different from the second form.

3. The processing method according to claim 1, wherein acquiring the target instruction includes:
transmitting and receiving the target instruction through the connection channel, the target instruction being generated by a target operation acquired by the target device.

4. The processing method according to claim 2, wherein acquiring the target instruction includes:
transmitting and receiving the target instruction through the connection channel, the target instruction being generated by a target operation acquired by the target device.

5. The processing method according to claim 2, wherein acquiring the target instruction includes:
transmitting and receiving the target instruction through the connection channel, the target operation being an adjustment operation for the first window acquired by the target device; and
determining the target instruction in response to the target operation information specifying that a size of the first window matches a size of the second window corresponding to the second screen projection mode.

6. The processing method according to claim 2, wherein acquiring the target instruction includes:
transmitting and receiving target operation information through the connection channel, the target operation being a target size acquired by the target device for the adjustment operation on the first window; and
determining the target instruction in response to the target operation information specifying that the target size of the first window matches a size of the second window corresponding to the second screen projection mode.

7. The processing method according to claim 1, wherein acquiring the target display content in the screen projection mode specified by the target instruction includes:
acquiring and sending first target display content in the first screen projection mode, wherein a first area of a target screen displays first display content in a first window based on the target instruction, and a size of the first window corresponding to a size of the first area; and
acquiring and sending second target display content in the second screen projection mode, wherein a second area of the target screen displays second display content in a second window based on the target instruction, and a size of the second window corresponding to a size of the second area.

8. The processing method according to claim 7, wherein the target operation is a split-screen operation acquired by the target device for the target screen, which divides the target screen into the first area and the second area that does not overlap the first area.

9. A processing device, comprising:
an establishment module, for establishing a connection channel with a target device including a target screen;
a first acquisition module, for acquiring a target instruction based on an instruction generated by a target operation acquired by the target device;
a second acquisition module, for acquiring target display content in a screen projection mode specified by the target instruction based on the target instruction; and
a sending module, for sending the target display content to the target device through the connection channel, wherein the target screen outputs the target display content in a target window.

10. The processing device according to claim 9, wherein:
the second acquisition module is further configured for acquiring the target display content based on the first screen projection mode;
the sending module is further configured for sending the target display content to the target device through the connection channel, wherein the target screen outputs the target display content in the first window in a first form;
the second acquisition module includes a switching unit configured for switching the screen projection mode from the first screen projection mode to a second screen projection mode based on the target instruction; and
the second acquisition module is further configured for acquiring the target display content based on the second screen projection mode, the target display content is sent to the target device through the connection channel, wherein the target screen outputs the target display content of the second window in a second form, the first screen projection mode is different from the second screen projection mode, and the first form is different from the second form.

11. The processing device according to claim 9, wherein the first acquisition module is further configured for transmitting and receiving the target instruction through the connection channel, the target instruction being generated by a target operation acquired by the target device.

12. The processing device according to claim 10, wherein the first acquisition module is further configured for transmitting and receiving the target instruction through the connection channel, the target instruction being generated by a target operation acquired by the target device.

13. The processing device according to claim 10, wherein the first acquisition module is further configured for:
transmitting and receiving target operation information through the connection channel, the target operation being an adjustment operation for the first window acquired by the target device; and
determining the target instruction in response to the target operation information specifying that a size of the first window matches a size of the second window corresponding to the second screen projection mode.

14. The processing device according to claim 10, wherein the first acquisition module is further configured for:
transmitting and receiving target operation information through the connection channel, the target operation being a target size acquired by the target device for the adjustment operation on the first window; and
determining the target instruction in response to the target operation information specifying that the target size of the first window matches a size of the second window corresponding to the second screen projection mode.

15. An electronic device, comprising:
one or more processors, and at least one memory containing computer program that, when being executed, causes the one or more processors to perform: establishing a connection channel with a target device including a target screen;
acquiring a target instruction based on a target operation acquired by the target device;
acquiring target display content in a screen projection mode specified by the target instruction; and
sending the target display content to the target device through the connection channel, wherein the target screen outputs the target display content in a target window.

16. The device according to claim 15, wherein before acquiring the target instruction, the one or more processors are further configured to perform:
acquiring the target display content based on a first screen projection mode;
sending the target display content to the target device through the connection channel, wherein the target screen outputs the target display content of a first window in a first form; and
for acquiring the target display content in the screen projection mode specified by the target instruction:
switching the screen projection mode from the first screen projection mode to a second screen projection mode based on the target instruction, and
acquiring the target display content based on the second screen projection mode, the target display content being sent to the target device through the connection channel, wherein the target screen outputs the target display content of a second window in a second form, the first screen projection mode being different from the second screen projection mode, and the first form being different from the second form.

17. The device according to claim 15, wherein the one or more processors are further configured to perform:
transmitting and receiving the target instruction through the connection channel, the target instruction being generated by a target operation acquired by the target device.

18. The device according to claim 16, wherein the one or more processors are further configured to perform:
transmitting and receiving the target instruction through the connection channel, the target instruction being generated by a target operation acquired by the target device.

19. The device according to claim 16, wherein the one or more processors are further configured to perform:
transmitting and receiving the target instruction through the connection channel, the target operation being an adjustment operation for the first window acquired by the target device; and
determining the target instruction in response to the target operation information specifying that a size of the first window matches a size of the second window corresponding to the second screen projection mode.

20. The device according to claim 16, wherein the one or more processors are further configured to perform:
transmitting and receiving target operation information through the connection channel, the target operation being a target size acquired by the target device for the adjustment operation on the first window; and
determining the target instruction in response to the target operation information specifying that the target size of the first window matches a size of the second window corresponding to the second screen projection mode.
